(19) United States
(12) Patent Application Publication
(10) Pub. No.: US 2005/0105562 A1
(43) Pub. Date: May 19, 2005

(54) Bulk CAS bit change detection

(76) Inventors: Anthony Downing, Saffron Walden (GB); John Ansell, Hemel Hempstead (GB)

Correspondence Address: BARNES & THORNBURG, P.O. BOX 2786, CHICAGO, IL, 60690-2786, US

(21) Appl. No.: 10/718,410

(22) Filed: Nov. 19, 2003

(51) Int. Cl. H04J 3/12

(52) U.S. Cl. 370/522; 370/442

(57) ABSTRACT

A method of detecting changes in a continuous stream of channel associated signalling (CAS) data for a plurality of communication channels is described. The method comprises the steps of: writing a block of data to an area of a circular memory buffer as a plurality of rows; writing a next block of data to an area of the circular memory buffer located sequentially after the area occupied by the previous block of data as a plurality of rows, wherein after writing each row of said next block of data, changes in the data contained in the row are determined by comparing the row with the corresponding row in the previous block of data; and repeating step (ii) a plurality of times.

### FIELD OF THE INVENTION

The present invention relates to channel associated signalling (CAS). In particular, the present invention relates to the bulk detection of changes in CAS data bits.

### BACKGROUND OF THE INVENTION

In communications networks, signalling equipment and signalling channels are required for the exchange of signalling information between network nodes. This signalling information informs the network nodes of line state changes, dialled digits and metering information of communication channels, for example voice channels.

Signalling information may be exchanged either by channel associated signalling (CAS) or common channel signalling (CCS). A characteristic feature of CAS is that signalling information is transported along the same route as the payload data. In contrast, a characteristic feature of CCS is that signalling information is transported via a dedicated network. Although most new communication networks employ CCS, a large proportion of existing communications networks, especially in North America, continue to employ CAS. There is therefore a requirement for new equipment for existing networks that is able to support CAS.

The transmission part of a telecommunications network includes trunk circuits and access circuits. The trunk circuits are composed of multiplexed communications channels of varying capacity and connect the various nodes of the network together. The access circuits connect user terminals to the various nodes of the network and have a smaller capacity.

At a node of the trunk network, a TDM (time division multiplexing) card may extract the incoming CAS. The extracted CAS data may then be received in series by a digital signal processor (DSP) over its Enhanced Synchronous Serial Interface (ESSI). According to the European “E1” standard, a timeslot of CAS data for each trunk is received every 125 μs. 32 rows of such data (a block), corresponding to 32 communication channels of each trunk, are received in series before the timeslot corresponding to the first channel is received again 4 ms later.

For the North American “T1” standard, a timeslot of CAS data for each trunk will be received every 125 μs. 24 rows of data are received in series before the timeslot corresponding to a first communication channel appears again.

The method of transporting CAS from the TDM card to the DSP for processing is in ATM AAL1 cells over a backplane. Within each cell each timeslot of CAS data includes four binary data bits for the communication channel to which it corresponds, as well as framing and synchronisation bits. The four binary data bits contain information relating to line state changes, dialled digits and metering information.

For this bulk CAS processing implementation to the European “E1” standard, the DSP must monitor for changes in the four bits of CAS data of all 2592 (81 trunks×32 timeslots) communications channels (one block) every 4 ms, preferably as a background task. The DSP monitors changes in the CAS data rather than the actual value of the data because this is a more efficient technique. New data is received every 4 ms, but changes in the data occur with far less frequency, for example when a line state changes and so DSP data processing overhead may be minimised by monitoring for changes only.

A conventional method of detecting changes in incoming CAS data will now be described with reference to FIG. 1, which shows a schematic representation of the method.

Blocks of incoming CAS data 1 are written to first and second CAS ingress buffers 3, 5 of a DSP 2 by direct memory access (DMA). Although not shown in FIG. 1, an Enhanced Synchronous Serial Interface (ESSI) within the DSP 2 provides the interface that allows the TDM data to be written to the buffers 3, 5 by DMA. Alternate blocks of data are written to each of the first and second buffers 3, 5 so that only one buffer is written to at any one time. Each block of data is written in series as it is received from the TDM card 7, which takes 4 ms. Accordingly, a block of data is written to each of the buffers 3, 5 every 8 ms.

Once a complete block of data has been written to one of the buffers 3, 5, for example the first buffer 3, a processing core 9 of the DSP 2 has 4 ms to detect changes in the block of CAS data before it is overwritten by another block. Changes in the block of CAS data are detected by the processing core 9 by comparing it with CAS data contained in a status array 11. The status array 11 is a memory location in the DSP 2 that contains an internal copy of the CAS data of the previous block to that being compared.

Once the CAS data in the first buffer 3 has been compared with the CAS data in the status array 11, and any changes have been detected and notified 13, the CAS data in the first buffer 3 is transferred into the status array 11 for comparison with the next block of incoming CAS data.

The first buffer 3 is then overwritten by another block of CAS data, and the block of CAS data stored in the second buffer 5 is compared with the data in the status array 11 to detect and notify changes.

The conventional method continues in a loop for as long as CAS data is being received and monitored.

The conventional method of detecting changes in incoming CAS data suffers a number of drawbacks that affect its reliability and efficiency. Firstly, the comparison of an entire block of CAS data is a relatively time consuming task for the processing core of the DSP. This is partly because access by the processing core to a status array can be slow. If the comparison of a block of CAS data is not completed within 4 ms, a new block will overwrite the data causing errors to occur. Secondly, because the comparison is a time consuming task, it is difficult to schedule it so that the processing core is not blocked from performing other tasks. Thirdly, an entire block of data is compared together, even though its contents are received serially as a number of timeslots of data. Thus, from receipt, the method takes significantly longer to determine changes in the first timeslots of the block of data than the last timeslots.

### SUMMARY OF THE INVENTION

According to a first aspect of the invention, there is provided a method of detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the method comprising the steps of: (i) writing a block of data to an area of a circular memory buffer as a plurality of rows, each row comprising a predetermined number of timeslots of data; (ii) writing a next block of data to an area of the circular memory buffer located sequentially after the area occupied by the previous block of data as a plurality of rows, each row comprising the predetermined number of timeslots of data, wherein after writing each row of said next block of data, changes in the data contained in the row are determined by comparing the row with the corresponding row in the previous block of data; and (iii) repeating step (ii) a plurality of times.

By comparing the blocks of CAS data on a row-by-row basis, the requirement for a status array is eliminated. This is because, once a row of a block of data has been written to an area of the circular memory buffer, comparison with the corresponding row in the previous block of data may begin immediately. The comparison can therefore be completed before the corresponding row in the next block of data is written to the circular memory buffer. Furthermore, the average time for changes in a timeslot of data to be detected is reduced because the comparison can begin before an entire block of data has been written to the memory.

Throughout this description and the appended claims, the term “row” is intended to mean “region”, and not intended to be spatially limiting. For example, where a block of data is described above as being written to memory as a plurality of rows, this may involve individual rows being written to individual physical rows of a memory structure, several rows being written to each physical row of a memory structure or individual rows being written across several physical rows of a memory structure. In the first aspect of the invention, the step of writing a block of data to an area of a circular memory buffer as a plurality of rows preferably involves individual rows being written to individual physical rows of a memory structure.

Because only one row of CAS data is compared at a time, the comparison task is split into a large number of smaller tasks scheduled at regular intervals. This allows other tasks to be scheduled between the row comparisons, thus preventing other tasks from being blocked.

In step (ii), comparing the row with the corresponding row in the previous block preferably comprises: locating the corresponding row in the previous block by applying a fixed memory offset from the location of the row; reading the corresponding row in the previous block; and comparing the CAS data bits in each timeslot of the row with the CAS data bits in each timeslot of the corresponding row of the previous block. By applying a fixed memory offset, the processing core of a DSP can quickly locate and read the corresponding row of data from the previous block with a low processing overhead.

Data is preferably written to the circular memory buffer by direct memory access (DMA). In this way, DSP processing overhead may be minimised.

Preferably, in step (ii), after writing each row of the block of data, an interrupt is generated, and changes in the data contained in the row are determined in response to the interrupt. The use of an interrupt provides an efficient trigger for the executing the task of determining changes in the row of data.

In embodiments, a row of data is written to the circular memory every 125 μs. Each row of data may comprise 81 or 66 timeslots of CAS data in series. The timeslots in a row may contain CAS data for respective trunks. Each block of data may comprise 32 or 24 rows of data in series. The rows in a block may contain CAS data for respective channels of trunks.

All blocks of data are preferably written to one of two areas of the circular memory buffer. In this way, blocks are overwritten with newly received blocks. This arrangement minimises memory requirements. The size of each area of the circular memory buffer is preferably equal to the size of a block of data. The locations of the two areas of the circular memory are preferably consecutive. This also minimises memory requirements and limits the size of the fixed memory offset to the size of a block of data.

According to a second aspect of the invention, there is provided a computer software product encoded to cause a computer to execute the method described above. Preferably, the computer is a digital signal processor (DSP).

According to a third aspect of the invention, there is provided a processor and memory arrangement for use in detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the arrangement comprising: a circular memory buffer; and a processor arranged to: (i) write a block of data to an area of the circular memory buffer as a plurality of rows, each row comprising a predetermined number of timeslots of data; (ii) write a next block of data to an area of the circular memory buffer located sequentially after the area occupied by the previous block of data as a plurality of rows, each row comprising the predetermined number of timeslots of data, and, after writing each row of said next block of data, determine changes in the data contained in the row by comparing the row with the corresponding row in the previous block of data; and (iii) repeat step (ii) a plurality of times.

Preferably, the processor and memory arrangement is arranged so that, in step (ii), comparing the row with the corresponding row in the previous block comprises: locating the corresponding row in the previous block by applying a fixed memory offset from the location of the row; reading the corresponding row in the previous block; and comparing the CAS data bits in each timeslot of the row with the CAS data bits in each timeslot of the corresponding row of the previous block.

Preferably, the size of each areas of the circular memory is equal to the size of a block of data.

According to a fourth aspect of the invention, there is provided a communication network node comprising: a switch for routing trunks of communication channels; and the processor and memory arrangement described above.

### BRIEF DESCRIPTION OF THE DRAWINGS

An example of the invention will now be described in detail with reference to the accompanying drawings in which:

FIG. 1 shows a schematic representation of a conventional method of monitoring changes in CAS data;

FIG. 2 shows a typical structure of a timeslot of CAS data;

FIG. 3 shows a schematic representation of a typical format of CAS data for all of the communication channels handled by a node in a communication network;

FIGS. 4 and 5 show schematic representations of a method of monitoring changes in CAS data according to the invention; and

FIG. 6 shows a communication network node according to the invention.

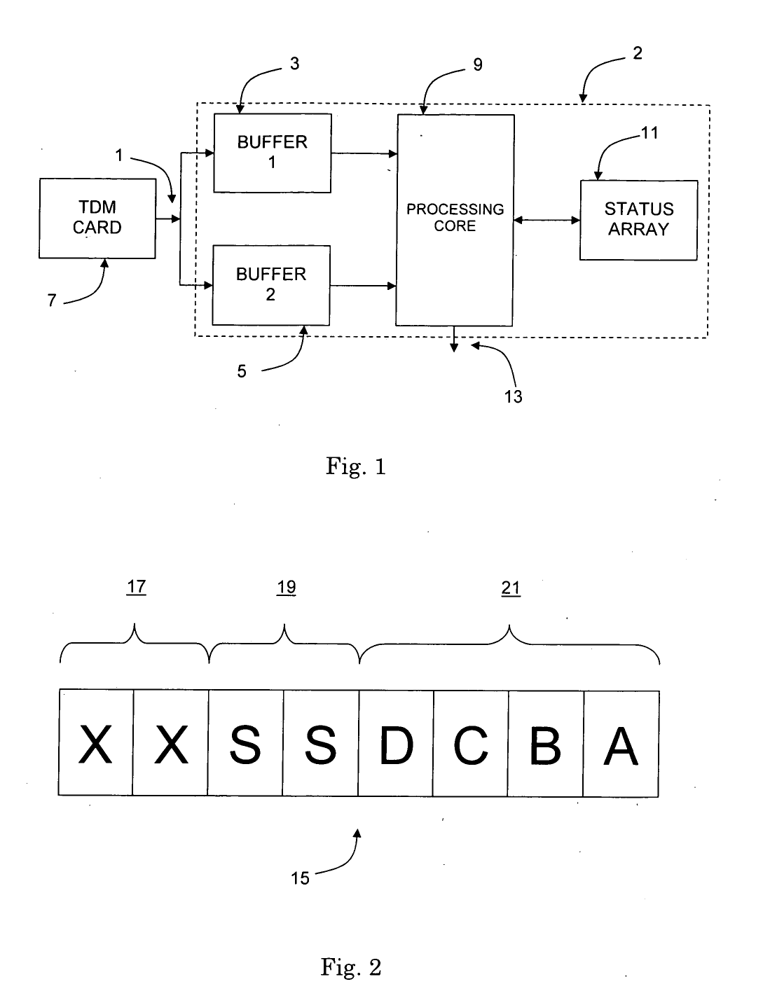

### DETAILED DESCRIPTION

FIG. 2 shows a typical structure for a timeslot of CAS data. The timeslot of CAS data 15 is one byte long and contains the CAS data for a single communication channel.

The first two bits of data in the timeslot are framing bits 17. The framing bits 17 delineate one timeslot of CAS data form the adjacent timeslots of CAS data. The next two bits of data in the timeslot are synchronisation bits 19. The synchronisation bits 19 identify the timeslot of CAS data for the first communication channel in a trunk. The timeslots for all other communication channels in the trunk can then be identified by reference to this timeslot of CAS data. The final four bits of data in the time slot are the CAS data bits 21. The CAS data bits 21 contain information on line state changes, dialled digits and metering information for the communication channel to which the timeslot applies.

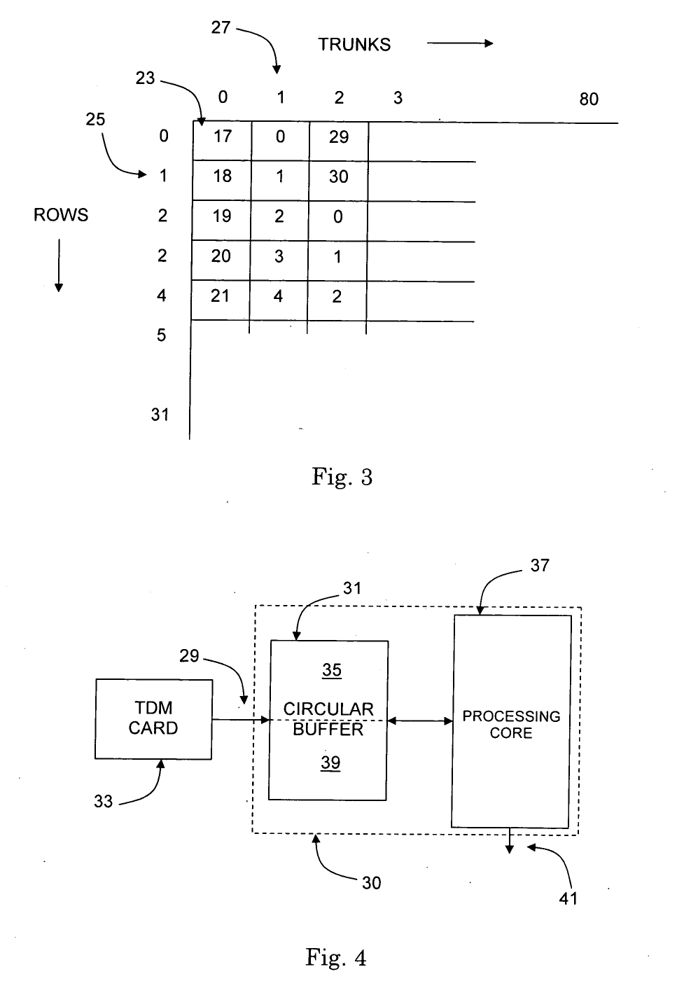

FIG. 3 shows a schematic representation of a typical format of CAS data for all of the communication channels handled by a node in a communication network. The communications channels handled by the node are grouped into 81 trunks, each comprising 32 communication channels.

As noted previously, the timeslots of CAS data 23 each contain the signalling information for a single communication channel handled by the node. The timeslots 23 are received in series at the node as a plurality of rows 25. Each row 25 contains a timeslot 23 for a communication channel of each trunk. Since there are 81 trunks handled by the node, each row contains 81 timeslots 23.

One complete row is received in 125 μs and is immediately followed by a next row. The next row contains a timeslot for another communication channel of each trunk. Since there are 32 communication channels in each trunk, a total of 32 rows are received in series by the node.

The 32 rows are received in 4 ms and contain one frame, or block, of CAS data for all of the communication channels handled by the node. While the node is operating normally, successive blocks of CAS data are continuously received in series.

It can be seen from FIG. 3 that the timeslots of CAS data for each trunk 27 (a column) are not synchronised. That is to say that the timeslot of CAS data for the first communication channel in each trunk is not necessarily contained in the same row. In FIG. 3, this lack of synchronisation is represented by the different numbers in the timeslot locations 23. For example, in FIG. 3, the timeslot for the first communication channel of trunk 1 is contained in row 0, but the timeslot for the first communication channel of trunk 2 is contained in row 2. As noted previously, the timeslot for the first communication channel of each trunk can be identified by the status of its synchronisation bits.

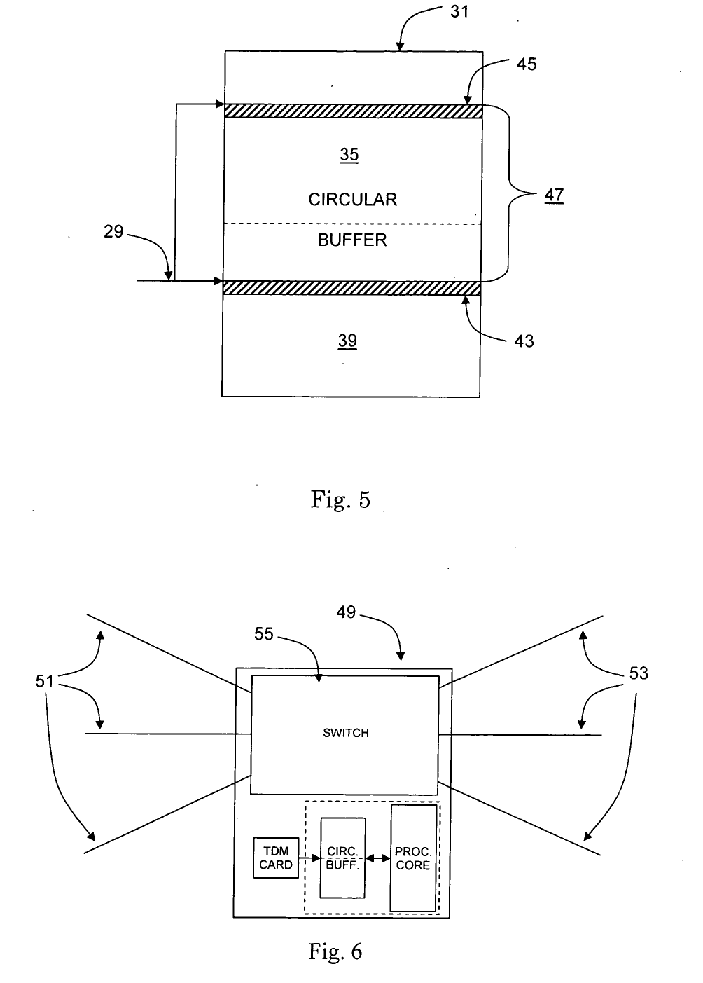

FIGS. 4 and 5 show schematic representations of a method of monitoring changes in CAS data according to the invention. The method will be described as applied to the CAS data format described above with reference to FIGS. 2 and 3. However, the skilled reader will appreciate that the method according to the invention may be applied to CAS data for a plurality of communication channels in any format, provided it is received in series.

Referring firstly to FIG. 4, blocks of incoming CAS data 29 are written to a circular memory buffer 31 of a DSP (digital signal processor) 30 by direct memory access (DMA). Although not shown in FIG. 4, an Enhanced Synchronous Serial Interface (ESSI) within the DSP 30 provides the interface that allows the TDM data to be written to the buffer 31 by DMA. Each block of data is written in series as it is received from the TDM card 33 and takes 4 ms.

A block of CAS data is written to a first area 35 of the circular memory buffer 31. The size of the first area 35 of the circular memory buffer 31 is equal to one block of CAS data. The block is written as 32 rows of data, each row comprising 81 timeslots. The 32 rows are written in series and, after each row has been written, an interrupt is generated which triggers a processing core 37 of the DSP 30 to compare the row of CAS data that has just been written with the corresponding row of CAS data in the previous block to be written to the circular memory buffer 31. This comparison step will be described in detail with reference to the next block of data that is written to the circular memory buffer 31. After comparing the CAS data, changes are determined and notified 41.

Once all 32 rows of the block of CAS data have been written to the first area 35 of the circular memory buffer 31, a next block of CAS data is written to a second area 39 of the circular memory buffer 31. The second area 39 of the circular memory buffer 31 is located sequentially after the first area 35 of the circular memory buffer 31. In fact, the first and second areas 35, 39 of the circular memory buffer 31 border each other. In common with the first area 35, the size of the second area 39 of the circular memory buffer is equal to one block of CAS data. The next block of CAS data is written as 32 rows of data, each row comprising 81 timeslots. The 32 rows are written in series and, after each row has been written, an interrupt is generated which triggers the processing core 37 of the DSP 30 to compare the row of CAS data that has just been written with the corresponding row of CAS data in the previous block that was written to the circular memory buffer 31.

This comparison step will now be described in more detail with reference to FIG. 5. Once a given row 43 of the block of CAS data has been written to the second area 39 of the circular memory buffer 31, a software interrupt routine is automatically called. This interrupt causes a software routine to run that causes the processing core 37 of the DSP 30 to compare the row that has just been written with the corresponding row 45 in the previous block of CAS data which is written in the first area 35 of the circular memory buffer 31. For example, if row 12 of the block has just been written, the processing core will compare that row with row 12 in the previous block of CAS data.

The processing core 31 locates the corresponding row 45 in the previous block by applying a fixed memory location offset 47 from the position of the row that has just been written 43 (modulus addressing). The fixed memory offset 47 maps from the row that has just been written 43 to the corresponding row in the previous block 45 and is the size of one block of CAS data.

Because the areas in which the blocks of CAS data are written 35, 39 are contiguous and are each the size of one block, the fixed memory offset 47 maps from any row that has just been written to the corresponding row in the previous block.

Once a complete block of CAS data has been written into the second area 39 of the circular memory buffer 31, a next block of CAS data is written to the circular memory buffer 31. Because the total size of the circular memory buffer 31 is equal to two blocks of CAS data, the next block of CAS data overwrites the block of CAS data that is written in the first area 35 of the circular memory array 31. This overwriting does not affect the comparison step for the previous block because only the first row is overwritten while the last row is being compared. Again, once each row has been written to the first area 35 of the circular memory array 31, it is compared with the corresponding row in the previous block of CAS data written in the second area 39 of the circular memory buffer 31. The fixed memory location offset 47 is used by the processing core 37 to map between the rows that are being compared.

The above method continues for as long as CAS data is being received by the node and processed by the DSP, with new blocks of CAS data sequentially overwriting previous blocks

The method is executed under the control of computer software running on the DSP 37.

FIG. 6 shows a communication network node 49 according to the invention. In addition to the TDM card and DSP described above, the node 49 comprises a switch 55 for routing trunks of communication channels 51, 53 across a wider network.

It is to be understood that this detailed description discloses a specific embodiment of a broader invention and is not intended to be limiting. There are many other embodiments within the scope of the invention as claimed hereafter, and these will be apparent to persons of ordinary skill in the art.

The hardware required to implement the method has not been described in detail because it is conventional and will be apparent to persons of ordinary skill in the art. Furthermore, it will be apparent that components of the embodiment described herein may be substituted for known equivalents or arranged in alternative arrangements. For example, the invention has been described with reference to CAS data of a specific format. However, other formats are possible, and thus memory area of differing sizes may be required.

1. A method of detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the method comprising the steps of:
(i) writing a block of data to an area of a circular memory buffer as a plurality of rows, each row comprising a predetermined number of timeslots of data;
(ii) writing a next block of data to an area of the circular memory buffer located sequentially after the area occupied by the previous block of data as a plurality of rows, each row comprising the predetermined number of timeslots of data, wherein after writing each row of said next block of data, changes in the data contained in the row are determined by comparing the row with the corresponding row in the previous block of data; and
(iii) repeating step (ii) a plurality of times.

2. The method of claim 1, wherein, in step (ii), comparing the row with the corresponding row in the previous block comprises:
locating the corresponding row in the previous block by applying a fixed memory offset from the location of the row;
reading the corresponding row in the previous block; and
comparing the CAS data bits in each timeslot of the row with the CAS data bits in each timeslot of the corresponding row of the previous block.

3. The method of claim 1, wherein data is written to the circular memory buffer by direct memory access (DMA).

4. The method of claim 1, wherein, in step (ii), after writing each row of the block of data, an interrupt is generated, and wherein changes in the data contained in the row are determined in response to the interrupt.

5. The method of claim 1, wherein a row of data is written to the circular memory buffer every 125 μs.

6. The method of claim 1, wherein all blocks of data are alternately written to one of two areas of the circular memory buffer.

7. The method of claim 6, wherein the size of each areas of the circular memory buffer is equal to the size of a block of data.

8. The method of claim 6, wherein the locations of the two areas of the circular memory buffer are consecutive.

9. The method of claim 2, wherein the size of the fixed memory offset is equal to the size of a block of data.

10. A computer software product encoded to cause a computer to execute a method of detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the method comprising the steps of:
(i) writing a block of data to an area of a circular memory buffer memory as a plurality of rows, each row comprising a predetermined number of timeslots of data;
(ii) writing a next block of data to an area of the circular memory buffer located sequentially after the area occupied by the previous block of data as a plurality of rows, each row comprising the predetermined number of timeslots of data, wherein after writing each row of said next block of data, changes in the data contained in the row are determined by comparing the row with the corresponding row in the previous block of data; and
(iii) repeating step (ii) a plurality of times.

11. The computer software product of claim 10 arranged so that, in step (ii), comparing the row with the corresponding row in the previous block comprises:
locating the corresponding row in the previous block by applying a fixed memory offset from the location of the row;
reading the corresponding row in the previous block; and
comparing the CAS data bits in each timeslot of the row with the CAS data bits in each timeslot of the corresponding row of the previous block.

12. The computer software product of claim 10 arranged so that data is written to the circular memory buffer by direct memory access (DMA).

13. The computer software product of claim 10 arranged so that, in step (ii), after writing each row of the block of data, an interrupt is generated, and wherein changes in the data contained in the row are determined in response to the interrupt.

14. The computer software product of claim 10 arranged so that a row of data is written to the circular memory buffer every 125 μs.

15. The computer software product of claim 10 arranged so that all blocks of data are alternately written to one of two areas of the circular memory buffer.

16. The computer software product of claim 15 arranged so that the size of each area of the circular memory buffer is equal to the size of a block of data.

17. The computer software product of claim 15 arranged so that the locations of the two areas of the circular memory buffer are consecutive.

18. The computer software product of claim 11 arranged so that the size of the fixed memory offset is equal to the size of a block of data.

19. A processor and memory arrangement for use in detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the arrangement comprising:
a circular memory buffer; and
a processor arranged to:
(i) write a block of data to an area of the circular memory buffer as a plurality of rows, each row comprising a predetermined number of timeslots of data;
(ii) write a next block of data to an area of the circular memory buffer located sequentially after the area occupied by the previous block of data as a plurality of rows, each row comprising the predetermined number of timeslots of data, and, after writing each row of said next block of data, determine changes in the data contained in the row by comparing the row with the corresponding row in the previous block of data; and
(iii) repeat step (ii) a plurality of times.

20. The processor and memory arrangement of claim 19 arranged so that, in step (ii), comparing the row with the corresponding row in the previous block comprises:
locating the corresponding row in the previous block by applying a fixed memory offset from the location of the row;
reading the corresponding row in the previous block; and
comparing the CAS data bits in each timeslot of the row with the CAS data bits in each timeslot of the corresponding row of the previous block.

21. The processor and memory arrangement of claim 19 arranged so that data is written to the circular memory buffer by direct memory access (DMA).

22. The processor and memory arrangement of claim 19 arranged so that, in step (ii), after writing each row of the block of data, an interrupt is generated, and wherein changes in the data contained in the row are determined in response to the interrupt.

23. The processor and memory arrangement of claim 19 arranged so that a row of data is written to the circular memory every 125 μs.

24. The processor and memory arrangement of claim 19 arranged so that all blocks of data are alternately written to one of two areas of the circular memory.

25. The processor and memory arrangement of claim 24, wherein the size of each areas of the circular memory is equal to the size of a block of data.

26. The processor and memory arrangement of claim 24, wherein the locations of the two areas of the circular memory are consecutive.

27. The processor and memory arrangement of claim 20 arranged so that the size of the fixed memory offset is equal to the size of a block of data.

28. A communication network node comprising:
a switch for routing trunks of communication channels; and
a processor and memory arrangement for use in detecting changes in a continuous stream of channel associated signalling (CAS) data for a plurality of communication channels, the CAS data comprising successive blocks of data transmitted in series, each block of data comprising a plurality of timeslots of data transmitted in series, each timeslot of data comprising a plurality of CAS data bits for a communication channel, the arrangement comprising:
a circular memory buffer; and
a processor arranged to:
(i) write a block of data to an area of the circular memory buffer as a plurality of rows, each row comprising a predetermined number of timeslots of data;
(ii) write a next block of data to an area of the circular memory buffer located sequentially after the area occupied by the previous block of data as a plurality of rows, each row comprising the predetermined number of timeslots of data, and, after writing each row of said next block of data, determine changes in the data contained in the row by comparing the row with the corresponding row in the previous block of data; and
(iii) repeat step (ii) a plurality of times.
